(19) United States
(12) Patent Application Publication
(10) Pub. No.: US 2004/0033327 A1
(43) Pub. Date: Feb. 19, 2004

(54) Surgical procedure system

(76) Inventors: Pierce E. Marks III, Augusta, GA (US); David H. Gibbs, Aiken, SC (US)

Correspondence Address: Michael S. Neustel, Suite No.4, 2534 South University Drive, Fargo, ND, 58103, US

(21) Appl. No.: 10/639,814

(22) Filed: Aug. 12, 2003

Related U.S. Application Data
(63) Continuation-in-part of application No. 10/141,214, filed on May 6, 2002, now Pat. No. 6,632,499.

(51) Int. Cl. B32B 9/00

(52) U.S. Cl. 428/42.3

(57) ABSTRACT

A surgical procedure system for reducing surgical site misidentification upon a patient. The surgical procedure system includes a sheet member with an operative label, a non-operative label and an allergy label removably attached to the sheet member. The surgical site is identified and then written upon the operative label. The health care professional and patient sign the operative label and then attach the operative label to the surgical site of the patient. The non-operative label is attached to the portion of the patient that is not to be operated upon. An allergy label may also be attached indicating any allergies the patient may have. The surgeon then removes the operative label prior to surgical preparation, signs the operative label and then places the operative label within the personal folder of the patient.

### CROSS REFERENCE TO RELATED APPLICATIONS

I hereby claim benefit under Title 35, United States Code, Section 120 of U.S. patent application Ser. No. 10/141,214 filed May 6, 2002. This application is a continuation-in-part of the Ser. No. 10/141,214 application. The Ser. No. 10/141,214 application is currently pending. The Ser. No. 10/141,214 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to surgical identification systems and more specifically it relates to a surgical procedure system for reducing surgical site misidentification upon a patient.

2. Description of the Related Art

Conventional hospital guidelines for surgical procedures typically require a “mark” upon the site to be operated upon (e.g. marker, pen, etc.). The main problem with conventional marking procedures is that they are susceptible to misidentification thereby potentially causing injury to a patient and liability to the hospital. Unfortunately, many patients have had the wrong body part operated upon, amputated or unnecessarily treated. Hence, there is a need for system that will reduce medical misidentification of patients.

In these respects, the surgical procedure system according to the present invention substantially departs from the conventional concepts and designs of the prior art, and in so doing provides an apparatus primarily developed for the purpose of reducing surgical site misidentification upon a patient.

### BRIEF SUMMARY OF THE INVENTION

In view of the foregoing disadvantages inherent in the known types of medical procedures now present in the prior art, the present invention provides a new surgical procedure system construction wherein the same can be utilized for reducing surgical site misidentification upon a patient.

The general purpose of the present invention, which will be described subsequently in greater detail, is to provide a new surgical procedure system that has many of the advantages of the medical procedures mentioned heretofore and many novel features that result in a new surgical procedure system which is not anticipated, rendered obvious, suggested, or even implied by any of the prior art medical procedures, either alone or in any combination thereof.

To attain this, the present invention generally comprises a sheet member with an operative label, a non-operative label and an allergy label removably attached to the sheet member. The surgical site is identified and then written upon the operative label. The healthcare professional (e.g. scrub nurse, surgical nurse, surgeon, resident, intern, anesthesiologist, etc.) and patient sign the operative label and then attach the operative label to the surgical site of the patient. The non-operative label is attached to the portion of the patient that is not to be operated upon. An allergy label may also be attached indicating any allergies the patient may have. The surgeon then removes the operative label prior to surgical preparation, signs the operative label and then places the operative label within the personal folder of the patient.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a surgical procedure system that will overcome the shortcomings of the prior art devices.

A second object is to provide a surgical procedure system for reducing surgical site misidentification upon a patient.

Another object is to provide a surgical procedure system that reduces medical malpractice, legal costs, time, insurance costs and the like.

An additional object is to provide a surgical procedure system that is efficient and easy to utilize.

A further object is to provide a surgical procedure system that warns medical personnel about potential allergic reactions to specific products.

Another object is to provide a surgical procedure system that clearly indicates the site intended for the surgical procedure.

A further object is to provide a surgical procedure system that clearly indicates the site not intended for the surgical procedure.

Another object is to provide a surgical procedure system that may be customized.

A further object is to provide a surgical procedure system that may be preprinted or printed on site.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart of the present invention.

FIG. 2 is a top view of a sheet member with the operative labels, the non-operative labels and the allergy labels.

FIG. 3 is a top view of the sheet member with one of the operative labels being removed from the sheet member.

FIG. 4 is a top view of a operative label.

FIG. 5 is a top view of a non-operative label.

FIG. 6 is a top view of the allergy labels.

FIG. 7 is a top view of the labels attached to a patient.

### DETAILED DESCRIPTION OF THE INVENTION

A. Overview

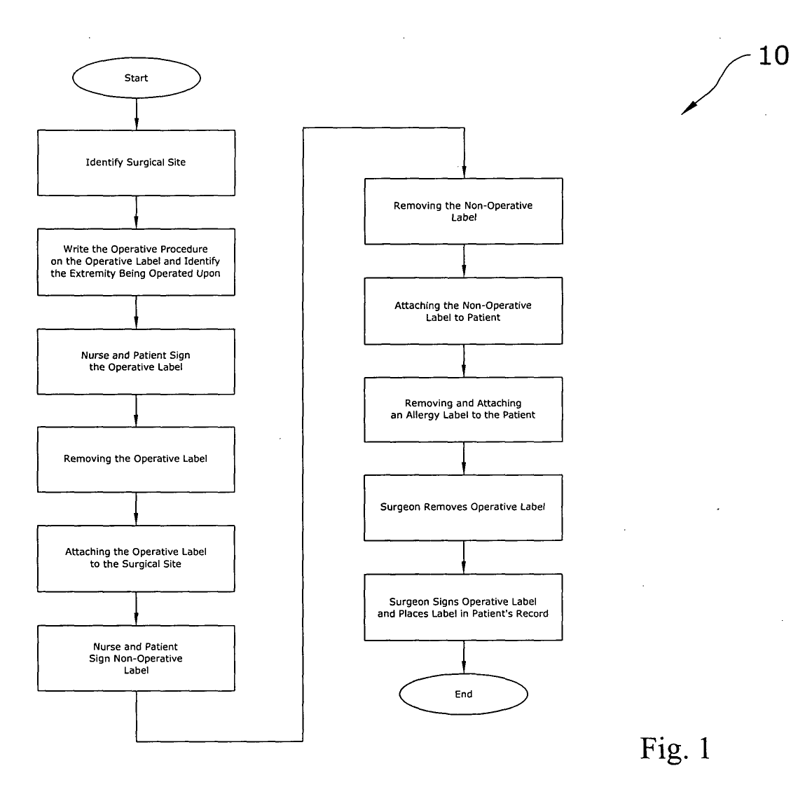

Turning now descriptively to the drawings, in which similar reference characters denote similar elements throughout the several views, FIGS. 1 through 7 illustrate a surgical procedure system 10, which comprises a sheet member 20 with an operative label 30, a non-operative label 40 and an allergy label 50 removably attached to the sheet member 20. The surgical site 14 is identified and then written upon the operative label 30. The health care professional and patient 12 sign the operative label 30 and then attach the operative label 30 to the surgical site 14 of the patient 12. The non-operative label 40 is attached to the portion of the patient 12 that is not to be operated upon. An allergy label 50 may also be attached indicating any allergies the patient 12 may have. The health care professional then removes the operative label 30 prior to surgical preparation, signs the operative label 30 and then places the operative label 30 within the personal folder of the patient 12. The labels 30, 40, 50, 60 are preferably have an adhesive attached to a backside of the labels for securing to a patient 12. The labels 30, 50, 60 are preferably comprised of an air permeable membrane or skin protection during longer surgeries and have an adhesive attached to the backside of the labels for securing to a patient 12.

B. Sheet Member

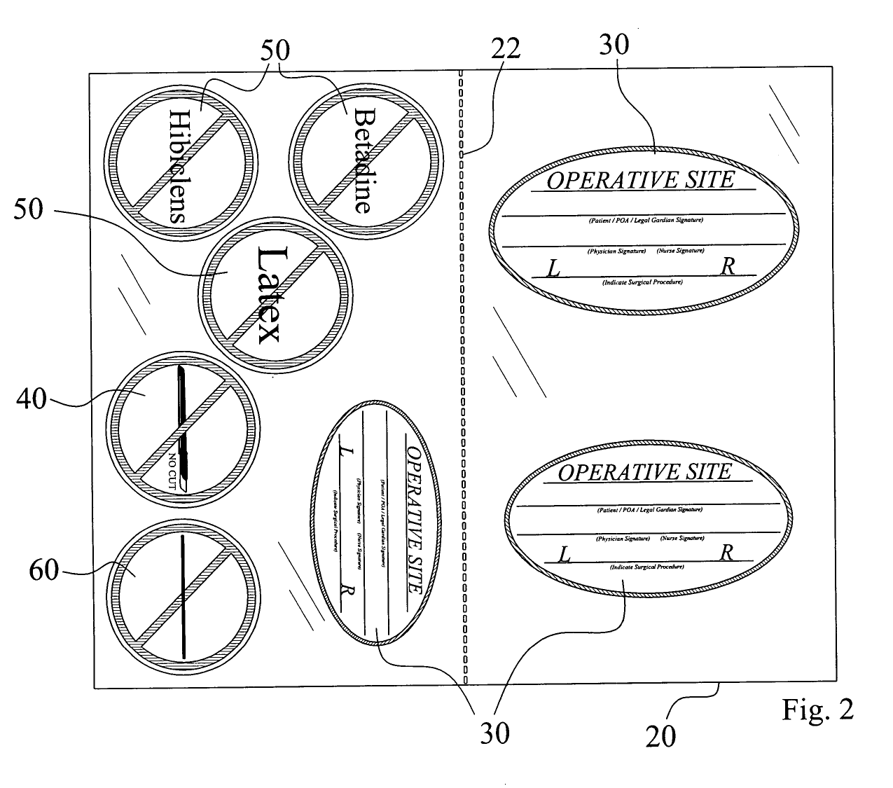

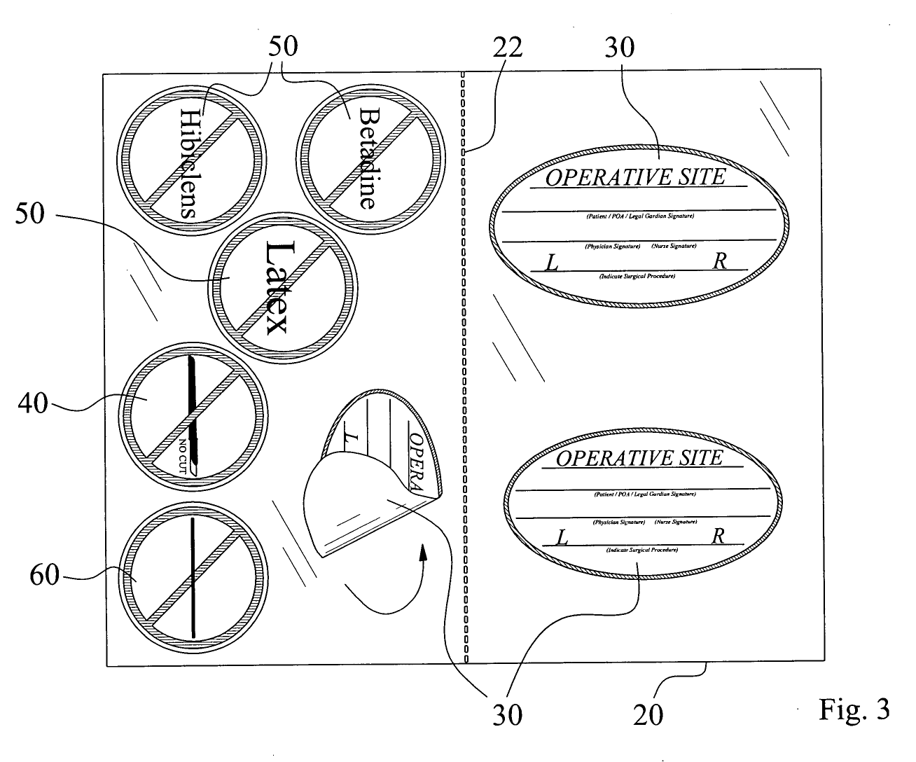

FIGS. 2 and 3 illustrate the sheet member 20. The sheet member 20 may be comprised of various materials, shapes and sizes. The sheet member 20 preferably has a surface that is suitable for removable attachment of labels.

The sheet member 20 preferably includes a plurality of perforations 22 for separating the operative labels 30 from the non-operative label 40 and allergy labels 50 as shown in FIGS. 2 and 3 of the drawings.

C. Operative Label

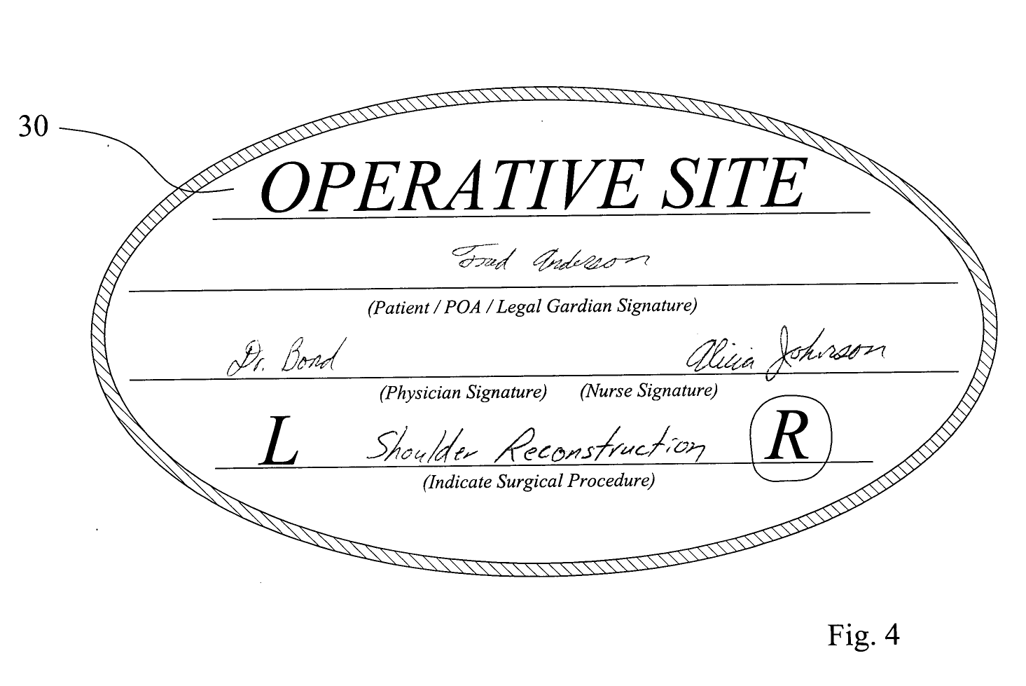

As shown in FIGS. 2 and 3 of the drawings, the operative label 30 is removably attached to the sheet member 20. There are preferably a plurality of operative labels 30 attached to the sheet member 20 that have various sizes and shapes as shown in FIGS. 2 and 3 of the drawings. FIG. 4 shows the operative label 30 as having an oval shape, however various other shapes may be utilized. Different sizes of operative labels 30 may be attached to the sheet member 20 to accommodate various sizes of surgical sites 14 on a patient 12. The operative label 30 is preferably comprised of a material that may be written upon by conventional writing instrument such as but not limited to pen, pencil, marker and the like.

As shown in FIG. 4 of the drawings, the operative label 30 includes a patient 12 signature space, a nurse signature space, a surgeon signature space and a surgical procedure space. The signature spaces preferably have a line with a label positioned beneath the line as shown in FIG. 4 of the drawings. Various other signature spaces may be included for other healthcare professionals such as but not limited to a scrub nurse, surgical nurse, resident, intern, anesthesiologist and the like.

The operative label 30 includes a left extremity and right extremity indicia for indicating the side extremity of a patient 12 a medical procedure is to occur as shown in FIG. 4 of the drawings. The left and right extremity indicia are preferably comprised of the letters L and R respectively that may be circled to indicate the extremity of the surgical site 14.

D. Non-Operative Label

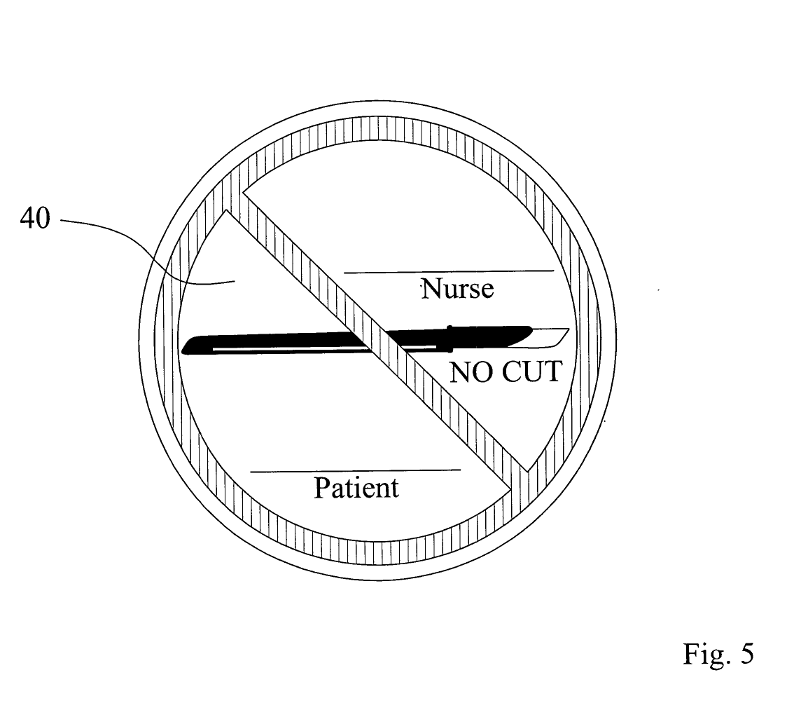

The non-operative label 40 is removably attached to the sheet member 20 as shown in FIG. 5 of the drawings. The non-operative label 40 has an international “do not” design of a cutting instrument surrounded by a circle and an angled cross line indicating a no cut area as further shown in FIG. 5 of the drawings. The non-operative label 40 may have a health care professional signature space and a patient signature space for acquiring written approval of a non-operative label 40 by a nurse and the patient 12 respectively.

E. Allergy Label

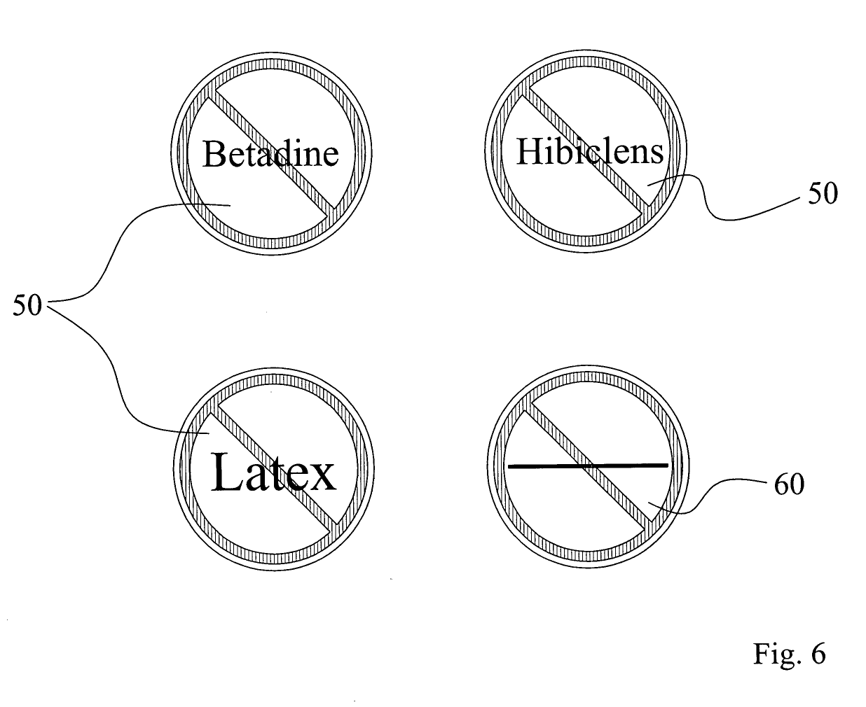

A plurality of allergy labels 50 are removably attached to the sheet member 20 as shown in FIGS. 2 and 3 of the drawings. The allergy label 50 includes an indicia representing a substance that a patient 12 is allergic to surrounded by a circle and an angled cross line extending through as shown in FIG. 6 of the drawings. For example, if a patient 12 is allergic to latex, the word latex is positioned upon the allergy label 50 to indicate that the surgeon and medical staff should not utilize latex gloves.

F. Supplemental Label

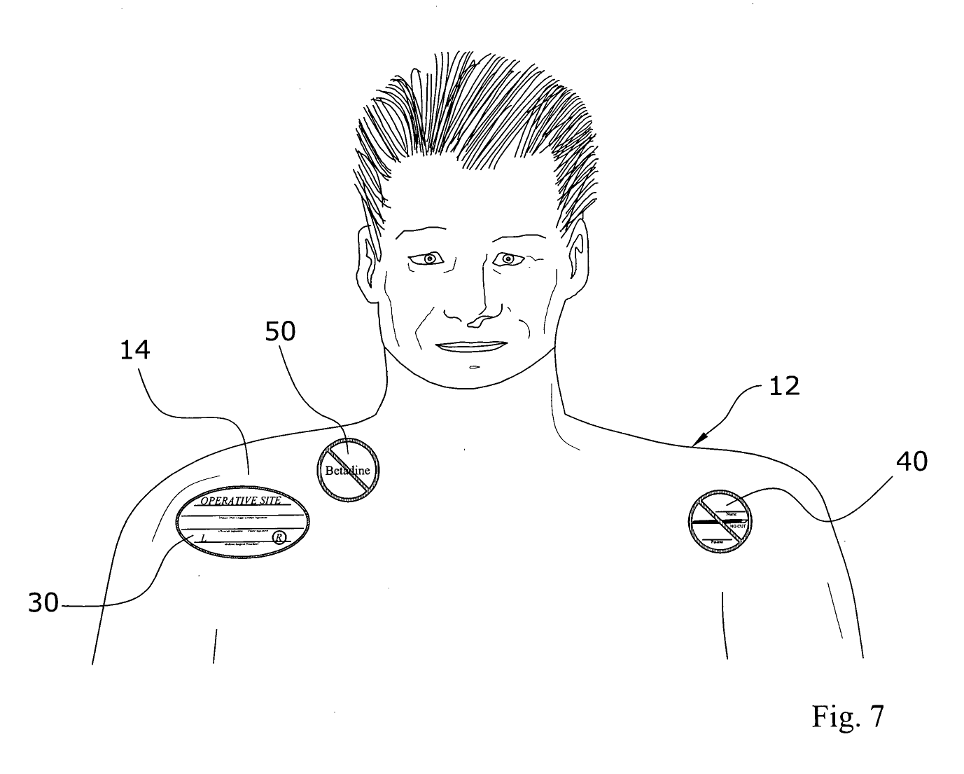

The supplemental label 60 is removably attached to the sheet member 20 as shown in FIGS. 2 and 3 of the drawings. The supplemental label 60 has a writing line for writing a non-desired condition surrounded by a circle and an angled cross line extending through as best shown in FIG. 7 of the drawings. Various subject matter may be written upon the supplemental label 60 as can be appreciated.

G. Operation

In operation, the surgical site 14 upon the patient 12 is first identified as shown in FIG. 1 of the drawings. The operative procedure that will be performed on the surgical site 14 of the patient 12 is then written upon the operative label 30 by a nurse or other medical assistant. The extremity of the patient 12 to be operated upon is also selected by circling L or R indicating the left or right side of the patient 12. After the nurse and the patient 12 have properly indicated the medical procedure and body extremity to be operated upon, the nurse and patient 12 both sign the operative label 30 indicating their approval to the same.

The operative label 30 is then removed from the sheet member 20 as shown in FIGS. 1 and 3 of the drawings. The operative label 30 is attached to the surgical site 14 of the patient 12 as shown in FIGS. 1 and 7 of the drawings.

The nurse and the patient 12 then both preferably sign the non-operative label 40 as shown in FIG. 1 of the drawings, though signatures are not required. The non-operative label 40 is then removed from the sheet member 20 and attached to the side of the patient 12 opposite of the operative label 30 as shown in FIG. 7 of the drawings indicating where not to operate. The above-stated procedure may be performed in varying steps to accomplish a similar function.

If the patient 12 has any allergic reactions to certain materials, the appropriate allergy label 50 is then removed from the sheet member 20 and then applied to the patient 12 as shown in FIG. 7 of the drawings. The allergy label 50 indicates the types of materials that should not be utilized around the patient 12 to avoid an allergic reaction. A supplemental label 60 may be provided for writing a non-desired condition.

Prior to prepping the surgical site 14 for surgery, the surgeon removes the operative label 30 from the surgical site 14. This ensures that the surgeon has complete knowledge of the location of where the surgery is to occur. The non-operative label 40 provides additional protection by remaining upon the patient 12 so as to indicate where not to perform the surgery. The surgeon then signs the operative label 30 and then places the signed operative label 30 into the personal folder/record of the patient 12. The surgeon is then able to prep the surgical site 14 and perform the necessary surgery.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A surgical procedure system, comprising:
a sheet member;
an operative label removably attached to said sheet member;
a non-operative label removably attached to said sheet member; and
an allergy label removably attached to said sheet member.

2. The surgical procedure system of claim 1, including a plurality of perforations within said sheet member separating said operative label from said non-operative label and said allergy label.

3. The surgical procedure system of claim 1, wherein said operative label includes a patient signature space.

4. The surgical procedure system of claim 3, wherein said operative label includes a health care professional signature space.

5. The surgical procedure system of claim 4, wherein said operative label includes a nurse signature space and/or a surgeon signature space.

6. The surgical procedure system of claim 1, wherein said operative label includes a surgical procedure space.

7. The surgical procedure system of claim 1, wherein said operative label includes a surgical procedure space.

8. The surgical procedure system of claim 7, wherein said non-operative label has a design of a cutting instrument surrounded by a circle and an angled cross line indicating a no cut area.

9. The surgical procedure system of claim 1, wherein said labels are comprised of an air permeable material and have an adhesive attached to a backside of said labels for securing to a patient.

10. The surgical procedure system of claim 1, including a supplemental label removably attached to said sheet member, wherein said supplemental label has a writing line for writing a non-desired condition surrounded by a circle and an angled cross line extending through.

11. The surgical procedure system of claim 1, wherein said allergy label includes an indicia representing a substance that a patient is allergic to surrounded by a circle and an angled cross line extending through.

12. The surgical procedure system of claim 1, wherein said operative label includes a left extremity and a right extremity indicia for indicating the side extremity of a patient a medical procedure is to occur.

13. A method of performing a surgical safety system, said method comprising the steps of:
(a) identifying a surgical site upon a patient;
(b) attaching an operative label to said surgical site indicating the location to perform an operative procedure;
(c) removing said operative label from said patient by a surgeon prior to surgical preparation; and
(d) signing said operative label by said surgeon.

14. The method of performing a surgical safety system of claim 13, including the step of (e) placing said operative label into a personal folder of said patient.

15. The method of performing a surgical safety system of claim 13, including the step of signing said operative label by a health care professional and a patient after step (a).

16. The method of performing a surgical safety system of claim 13, including the step of (e) attaching a non-operative label to a non-surgical site of said patient.

17. The method of performing a surgical safety system of claim 13, including the step of (e) attaching an allergy label to said patient indicating any allergies of said patient.

18. A method of performing a surgical safety system, said method comprising the steps of:
(a) identifying a surgical site upon a patient;
(b) writing an operative procedure upon an operative label;
(c) identifying an extremity of said patient to be operated upon selected from left or right;
(d) signing said operative label by a health care professional and said patient;
(e) removing said operative label from a sheet member;
(f) attaching said operative label to said surgical site indicating the location to perform an operative procedure;
(g) removing said operative label from said patient by a health care professional prior to surgical preparation;
(h) signing said operative label by said surgeon; and
(i) placing said operating label within a personal folder of said patient.

19. The method of performing a surgical safety system of claim 18, including the step of (j) attaching a non-operative label to a non-surgical site of said patient.

20. The method of performing a surgical safety system of claim 18, including the step of (j) attaching an allergy label to said patient indicating any allergies of said patient.
